(19) United States
(12) Patent Application Publication
(10) Pub. No.: US 2026/0127932 A1
(43) Pub. Date: May 7, 2026

(54) CONTROLLING ROULETTE ZONE FEATURE

(71) Applicant: LNW Gaming, Inc., Las Vegas, NV (US)

(72) Inventors: Harikesh KUTTIPARAMBIL, Thrissur (IN); Aljosa KRUPENKO, Jesenice (SI); Dougal AUSTIN, Reno, NV (US)

(21) Appl. No.: 19/379,321

(22) Filed: Nov. 4, 2025

Related U.S. Application Data
(60) Provisional application No. 63/717,094, filed on Nov. 6, 2024.

(51) Int. Cl. G07F 17/32

(52) U.S. Cl. CPC G07F 17/323; G07F 17/3213; G07F 17/3241; G07F 17/3262; G07F 17/3288

(57) ABSTRACT

A method and/or system to perform operations associated with a gaming system. The operations include tracking outcome statistics over a range of roulette games and, based on analysis of the statistics, animating a highlight effect over a zone of a roulette wheel that corresponds to a subset of wheel number values (e.g. a contiguous grouping of number wheel segments), which have, according to the analysis, a specific statistical relevance (e.g., a relatively higher combined statistical occurrence) than other subsets of wheel number values over the range. The operations further include detecting placement, during a roulette game, of one or more betting tokens via a section of a betting layout associated with the subset of wheel number values. The operations can further include automatically verifying the placement for the subset based on a type of bet and/or automatically updating statistics and zone position using an outcome of the most recent game.

### RELATED APPLICATIONS

This patent application claims priority benefit to U.S. Provisional Patent Application No. 63/717,094 filed Nov. 6, 2024, the disclosure of which is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024, LNW Gaming, Inc.

### FIELD

The present disclosure relates generally to gaming systems, apparatus, and methods and, more particularly, to presentation and control of roulette games via animations, highlighting and/or effects associated with gaming system features.

### BACKGROUND

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

Roulette is a well-known casino game which has been played for many years. A typical conventional roulette game includes a table bearing a felt covering upon which indicia forming a betting layout has been silk-screened or otherwise imprinted. A typical roulette wheel includes a number ring bearing a circular array of numbered segments bearing number values (or number indicia) “1” through “36.” The numbered segments may also be referred to as “pockets” as they each include a recessed portion, or “pocket,” into which a roulette ball can come to rest as a spin outcome for the game. The betting layout has individual betting spots that correspond to (and indicate) the number values. In addition to the number values “1” through “36,” the number ring (and corresponding betting layout) typically includes one or more additional number values (or number indicia) such as “0,” “00,” some combination thereof, etc. For example, a first version of roulette (called the “European” version) includes only the single “0” value on the roulette wheel and the betting layout whereas another version (called the “American” version) includes both the “0” and the “00” on the roulette wheel and the betting layout. Typically, for the American version, the “0” and the “00” are disposed at diametrically opposite locations on the number ring of the roulette wheel. The numbers values “1” through “36” are not disposed in numerical order, but are typically disposed in a predetermined arrangement based on the version of roulette being played. For example, the predetermined arrangement of the number values on the roulette wheel varies placement between the American version and the European version. The betting layouts may also appear different for the different versions of the game.

Furthermore, both the roulette wheel segments and/or betting spots on the betting layout that correspond to the number values typically bear the alternating colors of red and black, with the exception of the “0” and “00” number values, whose wheel segments and/or betting spots are typically colored green. A ring of pockets corresponding in number to the plurality of numbers of the circular number ring lies adjacent, but radially inward of the number ring, on the typical roulette wheel. In addition, a typical roulette wheel includes a circular, inclined ball track, disposed above, and radially outwardly of the number ring.

In operation of a typical roulette game, players place chips or tokens on the betting layout located on the roulette table, and then the dealer (referred to as a “croupier” in roulette) spins the roulette wheel to place the ball in motion about the circular ball track. As the roulette wheel slows, the ball moves radially inwardly and comes to rest in one of the pockets associated with a particular one of the numbers of the number ring. After the ball comes to rest in one of the pockets, the croupier or dealer settles the various wagers placed on the table layout in accordance with predetermined rules and wager odds.

A significant technical challenge with some games, including roulette, is to provide new and improved functionality of a gaming device that presents a game of roulette, for example, to provide an improved level of game play that uses new or improved gaming apparatus animations. Animations represent improvements to the underlying technology or technical field of gaming apparatus and, at the same time, have the effect of encouraging prolonged and frequent player participation.

### SUMMARY

According to one embodiment of the present disclosure, a method and/or system is described herein to perform operations associated with a roulette game. In one embodiment, the operations include tracking outcome results data for a range of roulette games performed by a roulette gaming system. The operations further include determining, based on analysis of the outcome results data, a zone on a roulette wheel that contains a subset of wheel number values associated with the outcome results data. In one example, the subset of wheel number values are associated with contiguous numbered segments of the roulette wheel. In one example, the roulette wheel is a virtual roulette wheel or a digital version of a physical roulette wheel. The operations further include animating a highlight effect overlaid onto a portion of roulette wheel associated with the zone. The operations further include animating (e.g., on a graphical user interface (GUI) of a player terminal of an electronic roulette system), a section on a betting layout corresponding to the zone (e.g., a section on a virtual betting layout presented via the GUI). The operations further include detecting, in response to user input received (e.g., via the GUI) for a given roulette game, placement of one or more tokens (e.g., virtual tokens) via the section. The placement of the one or more tokens corresponds to a user selection of the subset of wheel number values in the zone for the given roulette game. The operations further include presenting, via the roulette wheel, a random outcome for the given roulette game (e.g., generating the random outcome based on a random number generator (RNG) and animating the random outcome via a virtual roulette wheel presented via the GUI or via an electronic display). If the random outcome includes a member of the subset of wheel number values, the operations can include providing a payout based on placement of the one or more tokens via the section. The operations further include automatically updating the outcome results data based on the outcome, which automatically updates (e.g., the position and/or number values) of the zone.

According to another embodiment of the present disclosure, a system is disclosed having an image sensor, a digital display, and a processor. The processor is configured to execute instructions, which when executed, cause the system to perform operations to track, via the image sensor, outcome data of a physical roulette wheel for each wheel number value at a physical gaming table over a given range of roulette games. The operations are further to store the outcome data in a computer memory. The operations are further to present, via the digital display, a virtual representation of the physical roulette wheel. The operations are further to animate, via the digital display in response to automated analysis of the outcome data, a highlight effect over a zone of the virtual representation. The zone corresponds to a combined statistic associated with the subset of roulette wheel values over the given range of roulette games. The operations are further to automatically highlight, during a roulette game, a set of one or more bet spots on a betting layout. The set of one or more bet spots are for placement of one or more betting tokens associated with the subset of roulette wheel values in the zone.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a gaming system 100 configured for implementation with a virtual croupier according to at least some aspects of the disclosed concepts.

FIG. 2 is a schematic block diagram of a gaming system architecture 200 according to at least some aspects of the disclosed concepts.

FIG. 3 is a flowchart for controlling roulette zone features according to at least some aspects of the disclosed concepts.

FIG. 4 is a diagram of controlling one or more roulette zone features according to at least some aspects of the disclosed concepts.

FIGS. 5A, 5B, and 5C are diagrams of controlling one or more roulette zone features according to at least some aspects of the disclosed concepts.

FIG. 6 is a diagram of controlling one or more roulette zone features according to at least some aspects of the disclosed concepts.

FIG. 7 is a schematic block diagram of a gaming system 1300 for implementing embodiments in accordance with at least some aspects of the disclosed concepts.

FIG. 8 is a block diagram of a computer 1400 for acting as a gaming system for implementing embodiments according to at least some aspects of the disclosed concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

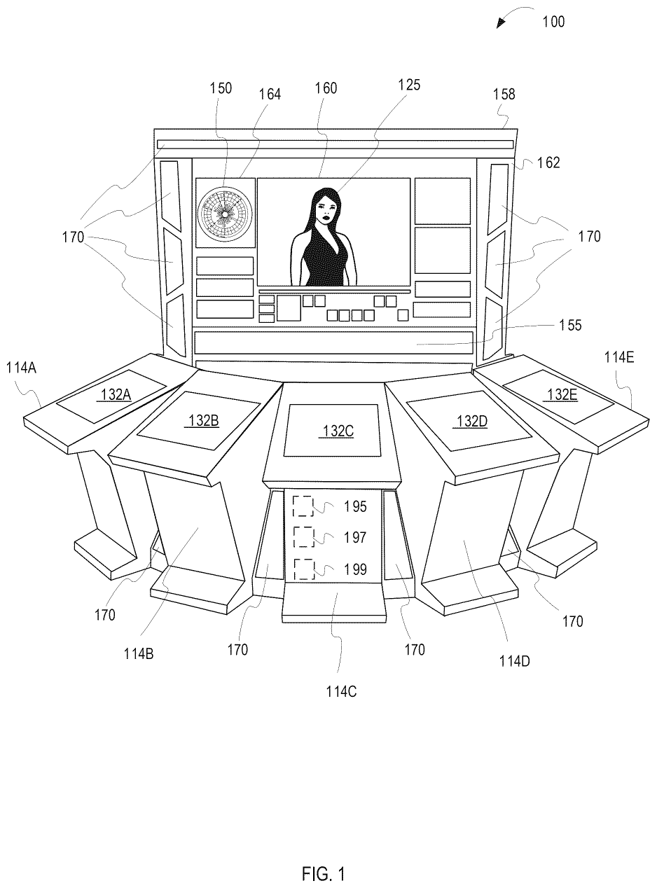

FIG. 1 is a perspective view of a gaming system 100 configured for implementation with a virtual croupier 125 according to at least some aspects of the disclosed concepts. One example of the gaming system 100 is described in U.S. patent application Ser. No. 17/948,755, filed Sep. 20, 2022 (i.e., the “Ser. No. 17/948,755 application”), in U.S. patent application Ser. No. 17/948,633, filed Sep. 20, 2022 (i.e., the “Ser. No. 17/948,633 application”), and in U.S. patent application Ser. No. 18/483,840 filed Oct. 10, 2023 (i.e., the “Ser. No. 18/483,840” application), which Ser. No. 17/948,755 application, Ser. No. 17/948,633 application, and Ser. No. 18/483,840 application are each incorporated by reference herein in their respective entireties. All patent applications, patents, and printed publications cited herein are incorporated herein by reference in the entireties, except to the extent that the incorporated material is inconsistent with the express disclosure herein, in which case the language in this disclosure controls.

The gaming system 100 includes player terminals 114A through 114E that are arranged in a bank around a video device 158. The video device 158 includes a roulette wheel screen 164 and a virtual croupier screen 160. In some embodiments, the virtual croupier screen 160 displays a video simulation of a croupier (e.g., virtual croupier 125) for interaction with the video device 158, such as through processing one or more stored programs stored in a memory 195 to implement the rules of game play at the video device 158. The virtual croupier screen 160 may be carried by a generally vertically extending cabinet 162 of the video device 158. The roulette wheel screen 164 may be configured to display at least a virtual roulette wheel 150 that responds to operations for the virtual croupier 125.

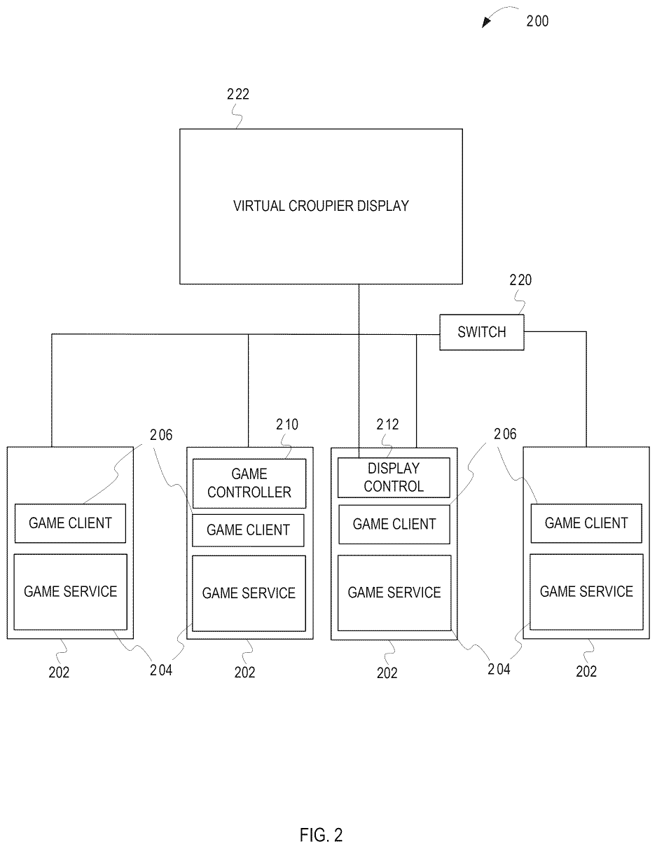

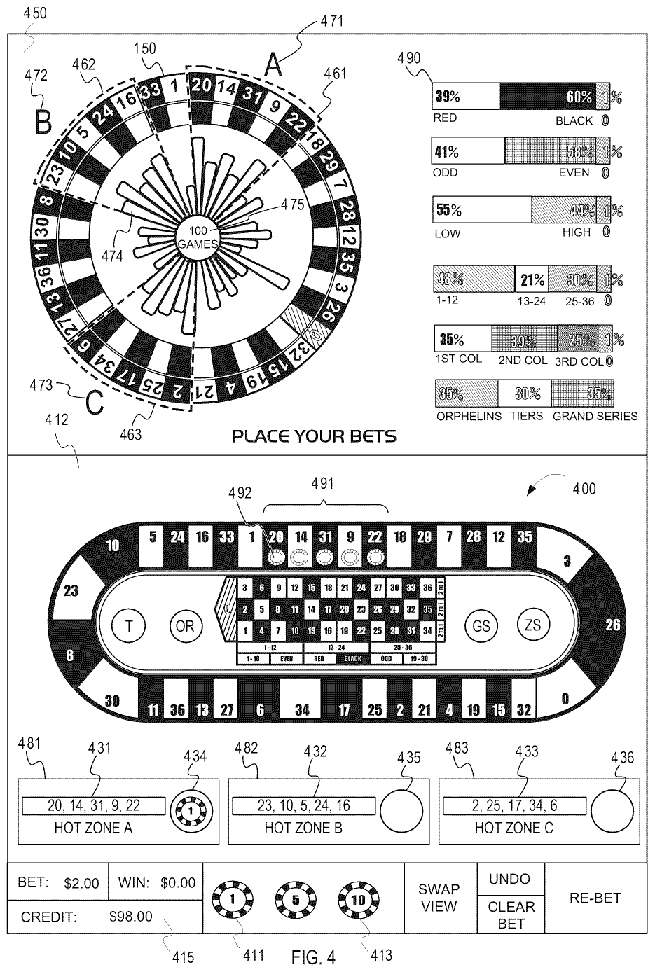

Each of the player terminals 114A through 114E includes a respective player interface area 132A through 132E that is configured for wagering and game play interactions with the video device 158 and/or virtual croupier 125. The player interface area 132A through 132E can present (depending on a display mode) either one of a user interface (e.g., see user interface 412 in FIG. 4) or a display (e.g., see display 450 in FIG. 4). Furthermore, in some embodiments, all or more of the portion (and/or content) of the display can be presented via the video device 158. Accordingly, game play may be accommodated without involving a physical roulette wheel, physical chips, and/or live personnel. The action may instead be simulated by a control processor 197 interacting with and controlling the video device 158. The control processor 197 may be located internally within, or otherwise proximate to, the video device 158, such as in one of the player terminals 114A through 114E. The control processor 197 may be programmed to implement the rules of game play at the video device 158. As such, in some embodiments, the control processor 197 interacts and communicates with display/input interfaces and data entry inputs for each player interface area 132A through 132E of the respective player terminals 114A through 114E. Other embodiments of gaming systems and gaming devices may include a control processor that may be similarly adapted to the specific configuration of its associated device. In some examples herein, the control processor 197 is referred to as a game controller (e.g., game controller 210). Furthermore, in some examples, the player terminals 114A through 114E can vary in number or location. For example, any of the player terminals 114A through 114E may be any one of the player terminals 202 described in FIG. 2.

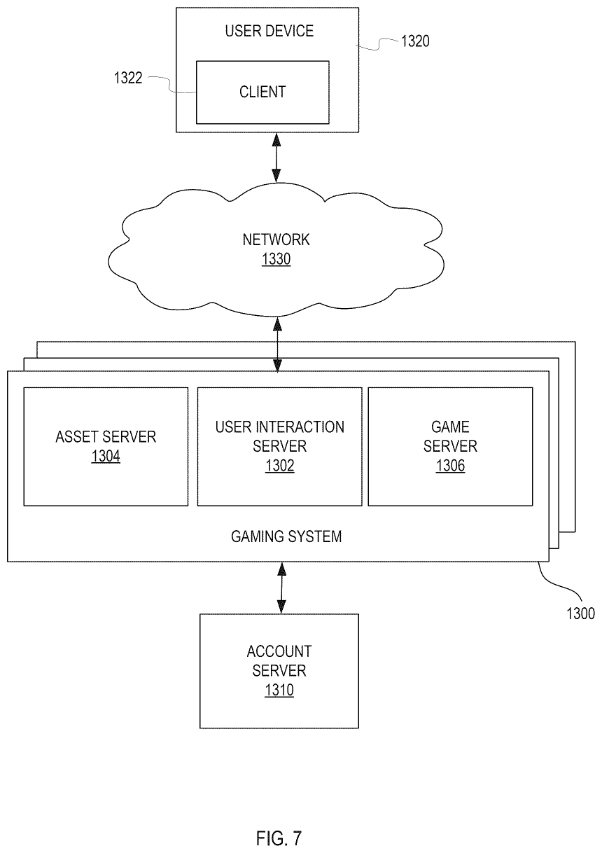

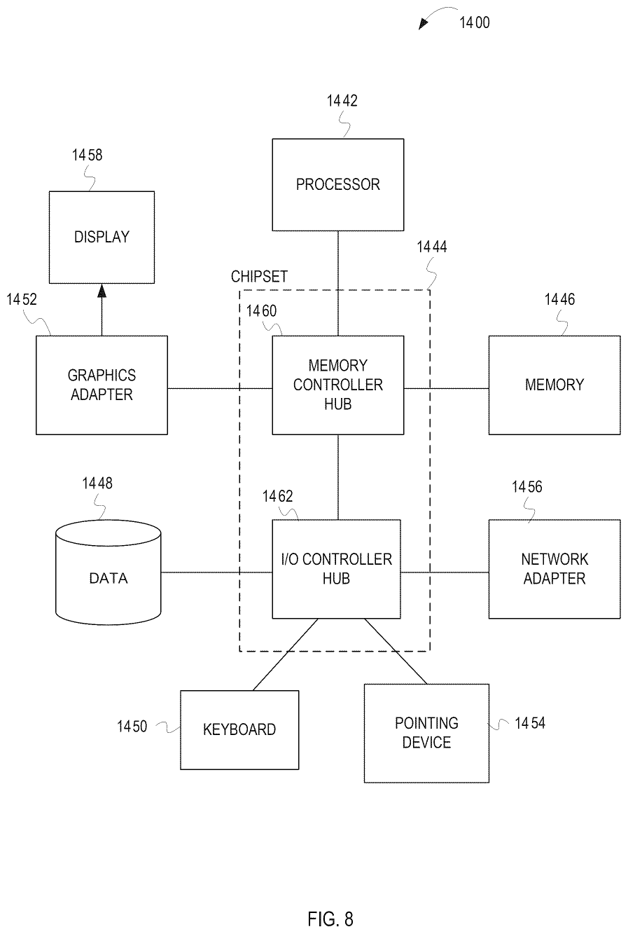

Still referring to FIG. 1, a communication device 199 may be included and operably coupled to the control processor 197 such that information related to operation of the gaming system 100, information related to the game play, or combinations thereof may be communicated between the gaming system 100 and other devices (not shown) through a suitable communication media, such, as, for example, wired networks, Wi-Fi networks, and cellular communication networks. In some embodiments, the communication device 199 is, or is associated with, switch 220 of FIG. 2, network 1330 of FIG. 7, or network adapter 1456 of FIG. 8.

Referring still to FIG. 1, the video device 158 may further include one or more banners 155 configured to communicate rules of play and/or the like, which may be located along one or more walls of the cabinet 162 or otherwise incorporated into the video device 158. The video device 158 may further include additional decorative lights (e.g., emotive lighting 170) and speakers (not shown). In some embodiments, the processor animates highlight effects with the decorative lights. For instance, the processor can select a color for the decorative lights that matches (e.g., an attribute or characteristic of) a highlight effect.

Further detail of an example of a table and/or gaming system and player displays is disclosed in U.S. patent application Ser. No. 10/764,995, filed Jan. 26, 2004, published as United States Patent Application Publication No. 2005/0164762 on Jul. 28, 2005, now U.S. Pat. No. 8,272,958, issued Sep. 25, 2012, and titled “AUTOMATED MULTIPLAYER GAME TABLE WITH UNIQUE IMAGE FEED OF DEALER,” the disclosure of each of which application and patent is incorporated herein in its entirety by this reference. Although an embodiment is described showing individual discrete player terminals, in some embodiments, the entire playing surface (e.g., player interface areas 132A through 132E, roulette wheel screen 164, etc.) may be an electronic display that is logically partitioned to permit game play from a plurality of players for receiving inputs from, and displaying game information to, the players, the dealer, or both.

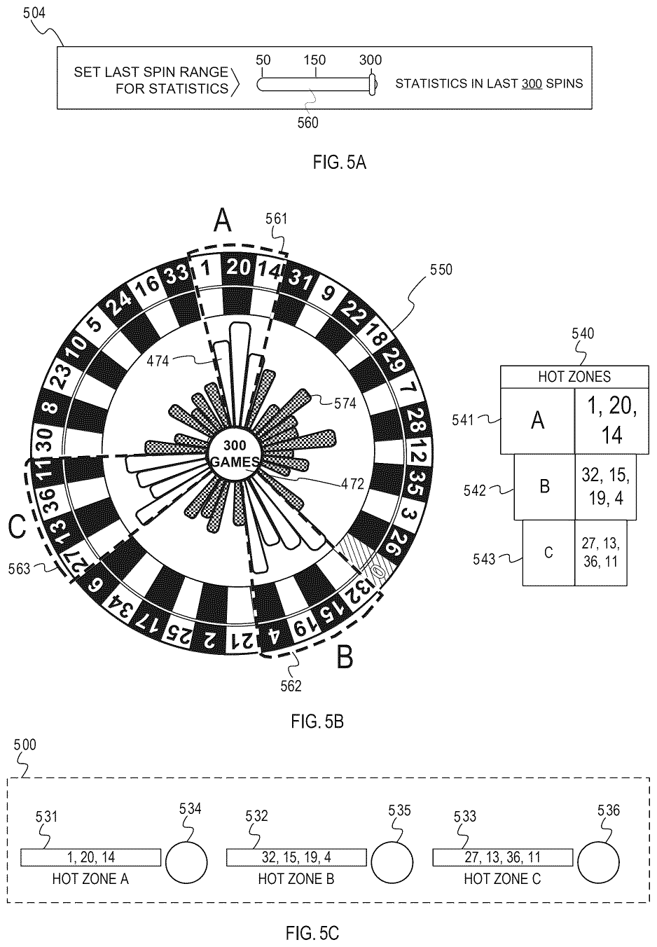

In some embodiments, the gaming system 100 is configured to present (e.g., in association with the virtual roulette wheel 150, on a betting layout presented via one of player terminals 114A-114E, etc.) one or more highlight effects associated with tracked data (e.g., tracked game statistics, tracked occurrences of events over a period or range, etc.). For example, in one embodiment the virtual roulette wheel 150 overlays highlight effects associated with statistics for each individual number value for each numbered segment (i.e., pocket) of the virtual roulette wheel 150 (e.g., see highlight effects 474 in FIG. 4). Furthermore, in some embodiments, the virtual roulette wheel 150 overlays (e.g., based on a zone hierarchy) highlight effects over one or more zones of the virtual roulette wheel 150 that comprise groupings of pockets associated with the tracked data (e.g., see highlight effects 461, 462, and 463 in FIG. 4 or highlight effects 561, 562, and 563 in FIG. 5B associated respectively with zones “A,” “B” and “C”). In addition, the player terminals 114A-114E present a betting layout 400 that includes sections (e.g., see sections 481, 482, and 483 in FIG. 4) which includes portions (e.g., subset values fields 431, 432, and 433 in FIG. 4 or subset values fields 531, 532, and 533 in FIG. 5C) that correspond to subsets of wheel number values associated with the highlighted zones on the wheel (e.g., associated with highlight effects 461, 462, and 463 or highlight effects 561, 562, and 563, which correspond respectively to zones “A,” “B,” and “C” of the virtual roulette wheel 150 or of virtual roulette wheel 550). Players can therefore bet concurrently on each of the number values included in the subset(s) of wheel number values. Yet further, in some embodiments, the gaming system 100 can dynamically update, after each game played, the subsets of wheel number values based on the updated tracked data given the outcome of the most recently played game.

FIG. 2 is a schematic block diagram of a gaming system architecture (“architecture 200”) according to at least some aspects of the disclosed concepts. The architecture 200 includes a plurality of player terminals 202 communicatively coupled via a network communication device (e.g., switch 220) to a virtual croupier display 222. The virtual croupier display 222 presents instructions from a virtual croupier for a group roulette game (e.g., as presented by video device 158 in FIG. 1). The virtual croupier display 222 is controlled by a display control 212 associated with one of the player terminals 202. The display control 212 is configured to present a roulette wheel (e.g., the display control 212 animates the roulette wheel 150 (see FIG. 1)) via the virtual croupier display 222. Furthermore a game engine (also referred to as game controller 210), is associated with a different one of the player terminals 202. The game controller 210 executes roulette-outcome logic, resets won progressive values, and contains a random number generator (RNG).

Each of the player terminals 202 includes a game client 206 that subscribes to a game service 204 associated with the roulette game. Each of the game clients 206 is configured to present game content (e.g., game assets for betting layouts, roulette wheels, highlight effects, etc.). In some embodiments, the game clients 206 are configured to present the game content and highlight effects via player interface areas 132A through 132E (shown in FIG. 1). In some embodiments, the game clients 206 are configured to present the game content via user interfaces (e.g., see user interface 412 in FIG. 4). Furthermore, in some embodiments, the game service 204 is associated with the game controller 210 and/or a game server (e.g., game server 1306 described for FIG. 7).

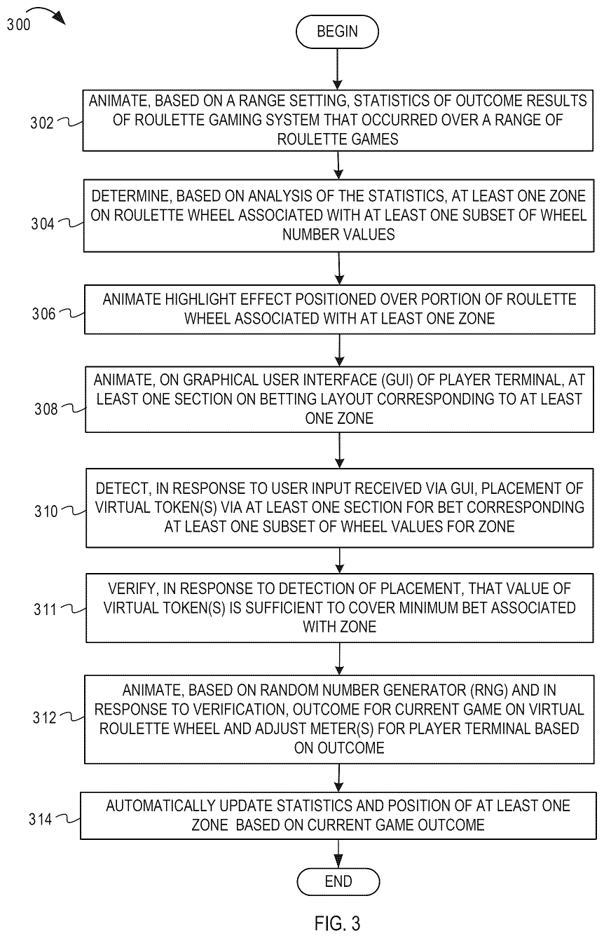

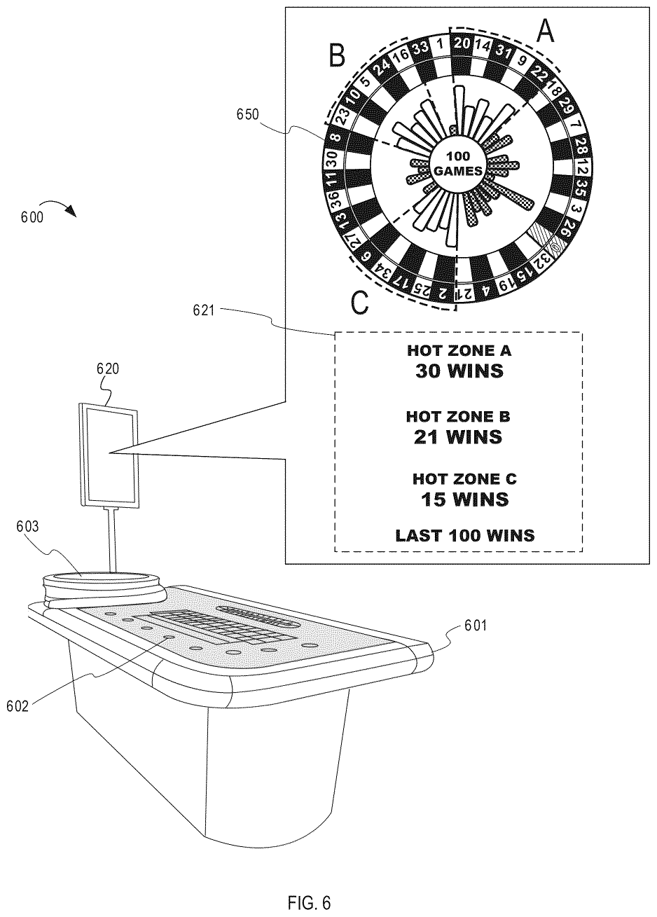

FIG. 3 is a flowchart of a flow (300) for controlling roulette zone features according to at least some aspects of the disclosed concepts. FIG. 4, FIG. 5A, FIG. 5B, FIG. 5C, and FIG. 6 are diagrams of controlling roulette zone features according to at least some aspects of the disclosed concepts. FIG. 1, FIG. 2, FIG. 4, FIG. 5A, FIG. 5B, FIG. 5C, and FIG. 6 will be referred to concurrently with the description of the flow 300. It should be noted that while some embodiments disclosed mention one or more devices that perform an action, the processor that performs the action may one of one or more processors that are available by a roulette gaming system (e.g., electronic roulette system, physical-table roulette system, a hybrid roulette system with electronic and physical components, etc.) and/or distributed across a gaming network.

Referring to FIG. 3, the flow 300 starts at processing block 302, where a processor animates, based on zone range settings, statistics of outcome results of a roulette gaming system that have occurred over range (e.g., outcome results that have occurred in the last N number of roulette games). In some embodiments, the statistics of the outcome results are of games that have occurred for an electronic roulette system, such as those described in FIG. 1, FIG. 2, FIG. 4, FIG. 5A, FIG. 5B, and FIG. 5C. In other embodiments, the statistics are of the outcome results of games that have occurred for a roulette gaming system such as roulette gaming system 600 shown in FIG. 6 having a physical gaming table 601. FIG. 4 illustrates an example of animating statistics in association with a virtual roulette wheel (e.g., virtual roulette wheel 150), presented via an electronic roulette system. For example, referring to FIG. 4, a display 450 of the electronic roulette system presents an image of virtual roulette wheel 150, as well as other information related to tracked data, such as game statistics (e.g., statistics graphics 490), which illustrate specific statistics related to certain outcomes for the last N number of roulette games played via the electronic roulette system. In some embodiments, the display 450 is attached to a player terminal (e.g., a display associated with any player interface area 132A-132E of any active one of the player terminals 114A-114E) and/or is separate from a player terminal (e.g., on roulette wheel screen 164 described in FIG. 1). In one embodiment (as shown in FIG. 5A) the display 450 can include at least one zone feature setting 504 with a user-input control (e.g., slider 560) which selects a range for the N value (e.g., to specify the last N number of games of the roulette wheel associated with the tracked statistics). Referring again to FIG. 4, the electronic roulette system presents a graphic 475 that specifies the number of games (e.g., the “N” value) selected via the setting 504.

Furthermore, in one embodiment, the roulette gaming system presents highlight effects (e.g., highlight effect 474) to illustrate, on the roulette wheel (e.g., to present on virtual roulette wheel 150), the statistics associated with each wheel number value. For example, the properties of each highlight effect 474 for each wheel number value can vary (e.g., varying size) to specify a degree of occurrence for each respective wheel number value within the last N games. For instance, a larger sized highlight effect 474 for a given wheel number value (e.g., for wheel number value ‘26’) indicates that the specific wheel number value occurred relatively more within the last N games (e.g., within the last “100” games) than for at least some other wheel number values, which would have relatively smaller sized corresponding highlight effect 474. Furthermore, the highlight effect 474 value can vary in other ways. For example, as shown in FIG. 5B, highlight effect 474 (e.g., a vibrant color, bright highlighting, high contrast, etc.) is applied to number values within a given zone, whereas a highlight effect 574 (e.g., a muted color, diminished brightness, low contrast, etc.) is applied to number values that are not inside a zone. In one example, diminished brightness to a highlight effect saves energy for the display by reducing power consumption for the display.

Referring again to FIG. 3, the flow 300 continues at processing block 304, where the processor determines, based on analysis of the statistics, at least one zone on the roulette wheel associated with a subset of wheel number values. For example, a roulette gaming system can group at least one subset of roulette wheel number values associated with specific roulette wheel segments into a zone based on the analysis of the statistics and/or based on criteria for the subset, such as a size of the zone range, a size of the number of members of a zone, a property of the zone (e.g., a criterion indicating whether the grouping of the zone members should be contiguous or non-contiguous), a statistical formula associated with a combined or collective computation for the subset of wheel number values, etc. In one embodiment, the roulette gaming system groups into the zone a subset of wheel number values associated with contiguous or adjacent pockets of the roulette wheel. Further, in one embodiment, the roulette gaming system can group a subset of wheel number values whose combined statistical average value of occurrence over the given range (e.g., over the last N number of roulette games) is highest amongst all other combined statistical average value of occurrence of any other subset (e.g., of similar size) on the wheel. Yet further, in one embodiment, the roulette gaming system can group subsets of contiguous wheel number values, where each of the grouped subsets have a combined statistical average value of occurrence over the given range that is higher than that of any other contiguous subsets that can be grouped on the roulette wheel, and where each grouped subset has a hierarchy of combined statistical average value of occurrence (e.g., one grouped subset has highest combined average, a next grouped subset has the next highest combined average, and so forth). The grouping of the subset of wheel number values according to the tracked criteria can, at least in one embodiment, illustrate a trend that the wheel number values in a zone (as a combined group) are “hot” (i.e., having occurred as a combined average more often more recently than other subsets of wheel number values over the range). Hence, in one embodiment, the zone may be referred to as a “hot zone.” However, other types of zones can be grouped differently based on differently tracked data and/or based on different zone settings or criteria. For example, some zones may be referred to as “cold zones” having a hierarchy of the lowest number of average combined results that occur the range. In another example, a zone may be a “won zone” referring to a subset of pockets whose values have won the most on average from bets placed over the range. Any statistic associated with game features (e.g., outcomes, betting history, appearance of certain special values, near misses, occurrence of other game events, etc.) can be a basis for a criterion for a zone.

In some embodiments, the size of a zone (e.g., the number of wheel number values grouped into a zone) can vary. For example, a zone feature setting can be set that specifies the zone size. In one embodiment, the zone size can vary based on the N value associated with the last N number of games. For example, if the tracked range of games is set (e.g., via slider 560 shown in FIG. 5A) to a low range (e.g., the last 50 games), then the zone size can include only three grouped wheel number values, whereas if the tracked range of games is set to a higher range (e.g., above 100 games), then the zone size can include five (or more) grouped wheel number values. Furthermore, in one embodiment, the zone sizes can vary based on given conditions, settings, events, levels, groupings, etc. For example, a first zone (e.g., zone “A”) can include a first number of grouped wheel number values (e.g., three wheel number values), whereas a second zone (e.g., zone “B”) can include a second (different) number of grouped wheel number values (e.g., four wheel number values), and so forth. For example, as in FIG. 5B, virtual roulette wheel 550 presents hot zone A (e.g., surrounded by highlight effect 561) which includes three wheel number values (i.e., number values “1,” “20,” and “14”), whereas hot zones B and C (associated with highlight effects 562 and 563 respectively) each have four wheel number values respectively (i.e., hot zone B includes the wheel values “32,” “15,” “19,” and “4” and hot zone C includes the wheel values “27,” 13,” “36,” and “11”). As shown in FIG. 5C, the subset members for hot zone A are presented via subset value field 531, the subset members for hot zone B are presented via subset value field 532, and the subset members for hot zone C are presented via subset value field 533. In some embodiments, the number of wheel numbers grouped into a zone can be random in size. In other embodiments, the sizes of different zones can vary within the same game or across different games. In some embodiments, the selection of the number of grouped wheel number values in each zone can be selected randomly or based on a configuration setting (e.g., set by, or associated with, an operator, a game participant, or some game activity). In one example, a player interface (e.g., player interface areas 132A-132E) may include a slider or other control that allows a user to manually select the number of wheel number values in each zone (e.g., thus affecting the potential risk and/or payout for the particular betting round). In some embodiments, an in-game event can specify, select, change, etc. the number, type, or other quality or quantity associated with the numbers (e.g., a bonus event occurs, which increases the number of values in a particular zone).

In some embodiments, the number of zones selected for presentation varies based on a setting and/or based on criteria. For example, a default setting may be set to determine a number of zones (e.g., three zones) presented according to a hierarchy of statistical levels. In other embodiments, the number of zones can vary automatically according to game conditions, past betting history, player preference, bonus events, modifiers, etc.

In some embodiments, each zone includes unique and/or separate wheel number values (no overlap of wheel number values from each zone in another other zone). In yet other embodiments, the zones can include some overlap of wheel number values in different zones. Furthermore, in some embodiments, the subsets of wheel number values for the zones may be grouped in a way that is other than as contiguously touching pockets. For example, a subset of pockets may be grouped to include number values that have occurred with the highest frequency. For example, the highest X number of outcome values that have hit in the last number of spins are grouped into zone “A” (even though they are not contiguous on the wheel), the next highest X number of outcome values that have hit in the last number of spins are grouped into zone “B,” and so forth.

Referring again to FIG. 3, the flow 300 continues at processing block 306, where the processor animates a highlight effect positioned over at least one portion of the roulette wheel associated with the at least one zone. For example, as shown in FIG. 4, the virtual roulette wheel 150 animates highlight effects 461, 462, and 463 to identify, on the virtual roulette wheel 150, the zones “A,” “B,” and “C.” For instance, highlight effect 461 surrounds the group of contiguous pockets for zone “A,” highlight effect 462 surrounds the group of contiguous pockets for zone “B,” and highlight effect 463 surrounds the group of contiguous pockets for zone “C.” Other embodiments include highlighting that is visually connected to only portions of the pockets (e.g., a border highlight appears only around the number values of a zone, a color is applied to a background of a portion of a numbered wedge, etc.). Furthermore, in other embodiments, the animated highlight effect may be projected onto a wheel or graphically rendered (e.g., via a virtual scene modeled according to a physical roulette wheel) to be overlaid onto an image of a physical roulette wheel.

In some embodiments, the roulette gaming system animates the highlight effect for a zone based on a hierarchy (e.g., a hierarchy of statistical levels) associated with different subsets of wheel number values. For instance, the roulette gaming system presents (e.g., modifies a property of) the highlight effect to a degree that reflects a hierarchal level (i.e., with hierarchical labels or other indicators of the levels). For example, the subset with the highest combined statistical average value of outcome occurrence for the range is marked (e.g., via label 471) as subset “A” (the first or highest ranking label or symbol in the hierarchy), the selected subset with the next highest combined statistical average value of outcome occurrence for the range (i.e., lower than for group “A,” but higher than any other subset) is marked (e.g., via label 472) as subset “B” (the second ranking label or symbol in the hierarchy), the selected subset with the next highest combined statistical average value of outcome occurrence for the range (i.e., lower than for either group “A” or for group “B,” but higher than any other subset) is marked (via label 473) as subset “C” (the third ranking label or symbol in the hierarchy). The highlighting is positioned over areas on the virtual roulette wheel 150 that are associated with the groupings of numbered wheel segments. The hierarchal indicators of the highlighted groupings illustrate the criteria (e.g., statistical level) associated with the tracked data. The player of the roulette game can see the highlighted zone(s) (e.g., the hot zones) on the virtual roulette wheel 150 and can select (on a layout associated with a player terminal) a token placement option associated with any zone. Thus, in one example, the gaming system provides options for players to place tokens on trends (e.g., a way to group and/or provide ways for players to make bets based on trends).

Multiple types of zones can be presented at once (or cycled through during a betting period), and the player terminal layout (for virtual token placement) automatically adjusts based on the type of zone being presented (or selected based on user input) to provide one or more highlights and/or betting options associated with the given zone (e.g., see processing block 308). Furthermore, in one embodiment, each zone can be highlighted digitally on the virtual roulette wheel 150 and/or in another section of the gaming system 100 separate from the virtual roulette wheel 150 (e.g., on any of the player terminals 114A through 114E, on any player interface area 132A through 132E, etc.). In one embodiment, statistics may be presented outside of the wheel (e.g., on the betting layout, in a table next to the wheel, etc.). For example, as shown in FIG. 5B, a table 540 is displayed showing each zone label and accompanying subset of wheel number values. In some embodiments, each displayed zone can have a different effect (e.g., differently sized highlight effects 541, 542, and 543, different colors, etc.) based on the hierarchy level. Furthermore, the labels for the zones may be illustrated herein as letters of an alphabet having a hierarchy of values (i.e., “A,” “B,” and “C”, where A represents the highest value, B the next highest, C the next highest). However it should be understood that letters of an alphabet are only one way of representing a hierarchy of values, and other embodiments may utilize other ways of doing so (e.g., number values (e.g., a first level zone is associated a first number, such as “1,” a second level zone is associated a second number, such as “2,” etc.), color-coded values (e.g., a first level zone has a highlighting of a first color, such as red, a second level zone has highlighting of a different color, such as green, etc.), different levels or types of highlighting (e.g., a first level zone has brightest highlighting, a second level zone has second brightest highlighting, etc.), and so forth.

Referring again to FIG. 3, the flow 300 continues at processing block 308, where the processor animates, on a graphical user interface (GUI) of the player terminal, at least one section on a betting layout that correspond to the at least one zone. For example, as shown in FIG. 4, the roulette gaming system presents betting layout 400 at each active player terminal. Each player terminal includes at least user interface 412. The player terminals can also include the display 450 and/or the display 450 may be presented on a communal display for the roulette gaming system. On the user interface 412 are controls, settings, objects, etc. that a player interacts with during a game of roulette. The user interface 412 includes the betting layout 400 for placement of one or more virtual tokens (e.g., to place one or more bets). In one example, the user interface 412 includes a plurality of different virtual tokens of differing denomination values (e.g., a token 411 worth $1, a token 413 worth $10, etc.). While only some denomination values are shown, other denomination values may be included (e.g., 15, 20, 25, 50, 100, etc.). In some embodiments, the other virtual tokens may be accessible via a user-interface object (e.g., via scroll control). In other embodiments, the ranges of denomination values may be automatically set based on other game factors, such as for a betting level or tier associated with a zone, an enhancer, a modifier, etc. A detailed description of how betting levels or tiers are associated with multiplier ranges can be found in the Ser. No. 17/948,755 application and/or the Ser. No. 17/948,633 application referenced previously. In one embodiment, instead of animating the section on a graphical user interface, the roulette gaming system can present an image of information associated with the zone onto a physical betting layout, such as via projection of content onto a felt covering or via backlighting from underneath the felt covering.

In some embodiments, the roulette gaming system animates (e.g., within sections 481, 482, and 483 shown in FIG. 4 or on betting layout 500 shown in FIG. 5C) images that (a) identify a zone (e.g., via a label such as zones “A,” “B,” or “C”), (b) identify the members of a specific subset of wheel number values associated with a specific zone (e.g., subset values fields 431, 432, and 433 shown in FIG. 4 or subset values fields 531, 532, and 533 shown in FIG. 5C associated respectively with zone “A,” “B,” and “C), as well as a (c) provide a betting spot or position (e.g., betting spots 434, 435, and 436 shown in FIG. 4 or betting spots 534, 535, and 536 shown in FIG. 5C, associated respectively with zone “A,” “B,” and “C”) onto which players can place virtual tokens for making concurrent bets on each member of the subset of wheel number values in a specific zone. As shown in FIG. 4, subset values field 431 identifies the values “20,” “14,” “31,” “9,” and “22,” which are the wheel number values within zone “A.” Subset values field 432 identifies the values “23,” “10,” “5,” “24,” and “16,” which are the wheel number values within zone “B.” Subset values field 433 identifies the values “2,” “25,” “17,” “34,” and “6,” which are the wheel number values within zone “C.” In the example shown in FIG. 5C, subset value fields 531, 532, and 533 are presented on betting layout 500. Subset values field 531 identifies the values “1,” “20,” and “14,” which are the wheel number values within zone “A;” subset values field 532 identifies the values “32,” “15,” “19,” “4” which are the wheel number values within zone “B;” and subset values field 533 identifies the values “27,” “13,” “36,” and “11,” which are the wheel number values within zone “C.” In some embodiments, such as via a roulette gaming system having a physical gaming table (e.g., FIG. 6), identifiers can be projected onto betting spots where a physical chip would need to be placed for each member of subset values within a particular zone. In other embodiments, the roulette gaming system can animate the section on a graphical user interface associated with a dealer station (e.g., a dealer display presents the betting zone and highlights the betting spots that are associated with any particular zone) for either placement, by dealer, of virtual chips on the betting spots presented on the display (in the case of virtual chip placement) or placement, by the dealer, of physical chips on corresponding physical betting spots for the zone printed on a felt covering of a physical betting layout (in the case of real-world chip placement).

Referring again to FIG. 3, the flow 300 continues at processing block 310, where the processor detects, in response to user input received via the GUI, placement of virtual token(s) via at least one section for a bet corresponding subset of wheel number values. For example, as shown in FIG. 4, a player can drag one or more of the virtual tokens onto a position (betting spot) on the betting layout 400 associated with the zone (e.g., a player drags one or more virtual tokens onto betting spot 434 to bet on the number values of zone “A”). When the player releases the drag-and-drop feature (e.g., when the player lifts their finger off of the user interface 412), the bet is placed. Once the croupier calls an end to betting (because the virtual token is in a betting spot), the bet is accepted for a bet type associated with the betting spot. The player terminal then locks the position of the virtual token in place onto the betting layout 400. In another embodiment, a dealer (or croupier) can drag virtual token(s) onto position(s) of betting spot(s) corresponding to the subset of wheel number values on a virtual betting layout presented on a dealer display. In other embodiments, such as for the roulette gaming system 600 in FIG. 6, the roulette gaming system 600 can detect (e.g., via pressure sensors, via environmental image sensors, via computer vision tracking, via machine learning model detection, etc.) placement of physical tokens on a physical layout via one or more sections associated with the zone (e.g., via a multi-value bet section associated with a zone, via each individual betting spot associated with a single-bet type on each number value of a zone, etc.).

Referring to FIG. 3, the flow 300 continues at processing block 311, where the processor verifies, in response to detection of placement of the virtual token(s), that the value of the virtual token(s) is sufficient to cover a minimum bet amount associated with the zone. For example, in FIG. 4, the betting layout 400 is configured for placement of various types of bets, such as a single-value bet type or a multi-value bet type. A single-value bet type involves a bet on an individual (single) value associated with the betting layout 400, such as a “straight up” bet. A multi-value bet type involves a bet on a group of values associated with the roulette wheel. Examples of multi-value bet types can be found in the Ser. No. 17/948,755 application and/or the Ser. No. 17/948,633 application referenced previously. Different bet types can be associated with different pay tables based on the bet type. For example, placement of the token(s) onto a zone bet spot (e.g. onto bet spot 434 for zone “A”) can, depending on a game feature settings, cause placement of either a single-value bet type (e.g., placement of individual straight-up bets on each wheel number value within a subset associated with a zone, with appropriate straight-up odds) or a multi-value bet type (e.g., placement of a single wager one the subset as a group where occurrence of any of subset wins). An example of a multi-value bet is similar to a bet on three numbers, a corner, five numbers, or six numbers, and the odds could be either slightly lower than “regular” or higher. Table 1 herein illustrates an example of a pay table of odds associated with a multi-value type bet for different sized zones.

TABLE 1

| Bet / zone | Regular | Zone payout | Zone payout |
|---|---|---|---|
| numbers | payout | min | max |
| 3 | 11 to 1 | 3 to 1 | 100 to 1 |
| 4 | 8 to 1 | 3 to 1 | 100 to 1 |
| 5 | 6 to 1 | 3 to 1 | 100 to 1 |
| 6 | 5 to 1 | 3 to 1 | 100 to 1 |

In one example, the roulette gaming system can verify the value of the bet by performing automated placement of virtual tokens (e.g., automated distribution of virtual token value across the subset, automated positioning of virtual tokens on layout positions associated with subset, etc.). For example, the betting layout 400 can dynamically adjust the number of virtual tokens required for placement of a certain bet type (e.g., single-value vs. multi-value). For example, placement of the virtual token onto betting spot 434 can cause an automatic placement of a separate token 492 (of same denomination as token on betting spot 434) on each of the betting spots on the layout 400 associated with the individual members of the subset (e.g., token 492 is placed on each individual bet position for each of the wheel number values listed in subset member field 431 as a straight-up bet on each wheel number value in the zone). Furthermore, the section 491 associated with the members of the zone can be highlighted (e.g., with placement of virtual token 492, with border highlights, with color-coded graphics corresponding to color of the corresponding highlight effect 461, etc.). In some embodiments, the roulette gaming system can verify (e.g., via artificial intelligence, via machine learning model tracking, etc.) that the placement of physical tokens on an associated bet spot(s) is sufficient to cover a minimum bet.

Referring to FIG. 3, the flow 300 continues at processing block 312, where the processor animates, based on random number generator (RNG) and in response to the verification, an outcome for the current game on the virtual roulette wheel and further adjusts one or more meters for the player terminal based on the outcome. For example, referring to FIG. 4, the roulette gaming system can detect, for a given game, whether the bet placed on any number value of a bet-upon zone resulted in a win based on the roulette game outcome. If so, the roulette gaming system updates a credit meter 415 with an amount of the win (e.g., a payout of a straight-up bet on the winning value from the zone, a payout of a group bet if any of the subset wins, etc.). The credit meter 415 can further be modified based on any bet amount transacted. Depending on the type of bet associated with the bet-upon zone, the gaming system can utilize a different pay table to update the credit meter 415 with an appropriate payout. In some embodiments, the roulette gaming system can automatically detect an outcome that occurs from a spin of a physical roulette wheel and can present a virtual version of the roulette wheel via a display (e.g., see virtual roulette wheel 650 presented via display 620). Furthermore, in some embodiments, the roulette gaming system (e.g., roulette gaming system 600), can pay out physical chips to a participant instead of updating a credit meter on a player terminal (e.g., as in gaming system 100 or as shown in FIG. 4).

Referring back to FIG. 3, the flow 300 continues at processing block 314, where the processor automatically updates the statistics, and the position of the zone, based on the game outcome. For example, the roulette gaming system can dynamically update, after each game played, the statistics associated with the tracked data, which causes the groupings of pockets to update (e.g., based on an update of statistics given the most recent game outcome). For example, wheel number values within each of the subset value fields 431, 432, and 433 update on the layout 400 (or wheel number values within each of subset value fields 531, 532, and 533 update on layout 500) as the statistics change per game. Thus, in at least one embodiment, the roulette gaming system provides an interactive feature that automatically updates in real-time the properties of the zone, enriching the overall gaming experience and automatically providing up-to-date zones per game. Furthermore, the dynamic updating after each game ensures players are consistently presented (e.g., on the virtual roulette wheel 150, on virtual roulette wheel 550, on virtual roulette wheel 650, on the player terminal, etc.) with relevant information, enhancing their decision-making and engagement.

In some embodiments, the processor automatically updates the statistics and/or other highlight effects based on a change of settings between game rounds. For example, as shown in FIG. 5A, if a user moves the slider 560, then the values of subsets will be modified based on the amount of tracked data now being used (e.g., statistics tracked over a range of 300 games would yield different statistics (e.g. for grouping of the zones) than statistics tracked over a range of only 100 games). Hence, as shown in FIG. 5B, for a range of 300 games, the zones include different subsets of wheel number values than those shown in FIG. 4 for a range of 100 games. Further, the embodiment shown in FIG. 5B updates, based on a change of the tracked range of past games, to includes a smaller zone size (e.g., three or four members per subset as shown in FIG. 5B as opposed to five members per subset shown in FIG. 4).

In other embodiments, a progressive award can be incorporated with zones. For example, in one embodiment, a zone feature setting for a gaming system enables progressive game functionality, such as by providing an option where if a player bets all of the zones, the player receives a special chip that has no value but must be placed on one straight-up number. If the roulette winning number matches the player's selected roulette number and the same number is in any of the zones, the gaming system provides a win for a highest progressive tier (e.g., player wins a Grand progressive). If, however, the winning number matches but is not in a marked zone, the player wins a lower-level progressive (e.g., a Major jackpot, a Minor jackpot, etc.). In other embodiments, the betting criteria associated with a progressive prize can bet can apply to any type of bet that is placed on a betting layout. For example, winning a placement of three straight-up bets can be part of a criteria for (e.g., to be eligible for, to trigger, etc.) a highest progressive (e.g., a “Grand”), whereas winning two straight-up bets can be part of a criteria for the next highest progressive (e.g., the “Major”), and so forth. In another example, placing a bet on at least half of a given set of numbers qualifies a player for a Grand, placement of a bet on at least a third of a given set of numbers qualifies a player for a Major, etc., and so forth. In one embodiment, the gaming system provides options for special side bets with, for example, a 10% hold on side bets, to provide for higher payouts and/or potential progressive wins. Furthermore, in some embodiments, the gaming system can set progressive odds and/or tiers based on the zone size (e.g., a selected zone size of two wheel number values for a first subset enables eligibility for a certain progressive jackpot, whereas a zone size of more than two wheel numbers enables eligibility for a different progressive jackpot).

Other embodiments include other types of configurations for other types of gaming systems. For example, some systems may utilize a virtual roulette wheel (e.g., virtual roulette wheel 150), such as be, but not limited to, a computer animated graphic of a physical roulette wheel, a video rendering of a physical roulette wheel, a photograph or video of a physical roulette wheel, a virtual recreation or model of a physical roulette wheel, etc. FIG. 6 illustrates an example of a roulette gaming system 600 having a physical gaming table (gaming table 601) and a roulette wheel section 603. In one embodiment, gaming table 601 can have printed bet spots on felt for placement of bets on particular zones associated with roulette wheel at the gaming table. In one embodiment, roulette wheel section 603 includes a physical roulette wheel monitored by electronics, sensors, etc. to detect and store game outcomes. In other embodiments, the roulette wheel section 603 instead includes a virtual roulette wheel (e.g., a digital rendering of a wheel, a video reproduction of a wheel, etc.). In one example, felt bets spots 602 on gaming table 601 can list different hot zones (e.g., “Hot Zone A,” “Hot Zone B,” or “Hot Zone C”), however the actual wheel number values for each hot zone (based on the statistics of the last number of games played) would be indicated on digital display 620 (e.g., display 620 presents an image of the roulette wheel, such as virtual wheel 650, as well as content 621 regarding the details and statistics for each hot zone). The players can call their preferred zone for betting, similar to “Call bets” (announce bets). For example, when a player calls “Hot Zone A,” straight-up bets can be placed on the corresponding bet positions of the betting layout of the gaming table 601. In one embodiment, a microphone at the gaming table can sense the sounds of a player calling a bet on a zone. In one embodiment, a machine learning model identifies the sounds of the player when making a call bet and notifies the croupier (e.g., via a dealer station). In some embodiments, cameras at the gaming table 601 (e.g., via computer vision, machine-learning-model tracking, etc.) can detect and track the wheel number values that have occurred as outcomes over the tracked range (e.g., via tracking the movement of the ball on the roulette wheel and storing, in memory, the history of the outcomes) for purposes regarding the zone(s) (e.g., for computation, interpretation, analysis, selection, configuration, placement, highlighting, pay table selection, etc. of the zones). A dealer station can indicate the subsets of wheel number values in the zones and/or other information related to the zones. In some embodiments, the table felt can be backlit (e.g., from underneath) to highlight information about the zones on the betting layout. In other embodiments, projection devices at the gaming table 601 can project onto the table felt information associated with zones and/or zone bets (e.g., projecting identifiers, highlight graphics, labels, etc. associated with the zones).

FIG. 7 is a schematic block diagram of a gaming system 1300 for implementing wagering games according to an embodiment of the present disclosure. The gaming system 1300 enables end users to access proprietary and/or non-proprietary game content through an online casino client 1322 (“the client 1322”). Such game content may include, without limitation, various types of wagering games such as card games, dice games, big wheel games, roulette, scratch off games (“scratchers”), and any other wagering game where the game outcome is determined, in whole or in part, by one or more random events.

The client 1322 may be an online casino that handles user funds and enables play of a wide variety of casino-style games, such as roulette, card games, dice games, slot games, and electronic gaming machine (EGM) games. A player accesses the client 1322 with a user device 1320 such as a personal computer, tablet, cell phone or other mobile device over a network, such as the internet or a closed casino network. Players are able to make real money wagers through the user device 1320 and the client 1322 delivers game results to the player over a network (not shown). Losses are taken by the online casino, and wins are paid out to the player. The client 1322 handles client funds and interacts with financial service providers to transfer funds in and out of the casino accounts. The server architecture of the client 1322 can take many forms. In one example, the client 1322 is operably connected to a separate remote gaming system 1300 that administers and delivers game results for one or more games, but in other embodiments, all of the online game play is administered in the client 1322. Exemplary gaming system 1300 delivers game results, administers game rules, and confirms wagers are made and that funds are available, but such system does not interact directly with users and does not handle player funds.

The wagering games supported by the gaming system 1300 may track player account balances and may use this information to confirm a game result can be delivered. The same system could be used to administer play-for-fun games in which account balances are tracked but do not represent real currency.

A virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 1300 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 1300 may include a gaming platform that establishes a portal for an end user to access via a user device 1320 to a wagering game hosted by a game server 1306 through a user interaction server 1302. The user device 1320 may communicate with user interaction server 1302 using a network 1330 (e.g., the Internet). The user interaction server 1302 may communicate with the game server 1306 and provide game information, such as graphical displays and game interactions to the user. In some embodiments, the functionality of the gaming system 1300 may be incorporated into the online casino client 1322. In some embodiments, the user device 1320 communicates with a game provided by the game server 1306, while other embodiments may include a plurality of user devices 1320 configured to communicate and provide end users with access to the same game provided by the game server 1306. In addition, a plurality of end users may be permitted to access a single user interaction server 1302, or a plurality of user interaction servers 1302, to access the game server 1306.

The user interaction server 1302 may communicate with the user device 1320 through the client 1322 to enable access to the gaming system 1300. The user may be unaware that the game is being administered by gaming system 1300 and not the client 1322. In embodiments, the user device 1320 includes a user display that includes game assets delivered from the asset server 1304 from gaming system 1300, as well as casino assets (such as the casino name, logo and other distinctive graphics) delivered by the client 1322. The user interaction server 1302 may enable a user to create and access a user account and interact with gaming server 1306. The user interaction server 1302 may enable users to initiate new games, join existing games, and interface with games being played by the user.

In some embodiments, the user interaction server 1302 may also provide the client 1322 for execution on the user device 1320 for accessing the gaming system 1300. The client 1322 provided by the gaming system 1300 for execution on the user device 1320 can comprise a variety of implementations according to the user device 1320 and method of communication with the gaming system 1300. In one embodiment, the user device 1320 connects to the gaming system 1300 using a web browser, and the client 1322 executes within a browser window or frame of the web browser. In another embodiment, the client 1322 is a stand-alone executable on the user device 1320.

In one embodiment, the client 1322 may comprise a relatively small amount of script (e.g., JAVASCRIPT®), also referred to as a “script driver,” including scripting language that controls an interface of the client 1322. The script driver may include simple function calls requesting information from the gaming system 1300. In other words, the script driver stored in the client 1322 may merely include calls to functions that are externally defined by, and executed by, the gaming system 1300. As a result, the client 1322 may be characterized as a “thin client.” As that term is used herein, the client 1322 may be little more than a script player. The client 1322 may simply send requests to the gaming system 1300 rather than performing logic itself for the games administered by gaming system 1300. The client 1322 may perform logic for other games that are not administered by gaming system 1300. For example, gaming system 1300 may administer an online casino's card games while all other games are administered by the client 1322. The client 1322 receives player inputs, and the player inputs are passed to the gaming system 1300 for processing and executing the wagering game. In one embodiment, this includes providing specific graphical display information to the client 1322 as well as game outcomes.

In other embodiments, the client 1322 comprises an executable file rather than a script. In that case, the client 1322 may do more local processing than does a script driver, such as calculating where to show what game symbols upon receiving a game outcome from game server 1306 through user interaction server 1302. In one embodiment, it may be that portions of an asset server 1304 are loaded onto the client 1322 and are used by the client 1322 in processing and updating graphical displays. Due to security and integrity concerns, some embodiments will have the bulk of the processing of the game play performed in the gaming system 1300. However, some embodiments may include significant game processing by the client 1322 when the client and user device 1320 are considered trustworthy or when there is reduced concern for security and integrity in the displayed game outcome. In most embodiments, it is expected that some form of data protection, such as end-to-end encryption, will be used when data is transported over network 1330. Network 1330 may be any network, including, but not limited to, the Internet, a communications network, a cell-phone network, a mobile device network, a wireless network, etc.

In an embodiment where the client 1322 implements further logic and game control methodology beyond the thin client, the client 1322 may parse and define player interactions prior to passing the player interactions to the gaming system 1300. Likewise, when the client 1322 receives a gaming interaction from the gaming system 1300, the client 1322 may be configured to determine how to modify the display as a result of the gaming interaction. The client 1322 may also allow the player to change a perspective or otherwise interact with elements of the display that do not change aspects of the game.

The gaming system 1300 may include the asset server 1304, which may host various media assets (e.g., audio, video, and image files) that may be sent to the client 1322 for presenting the various wagering games to the end user. In other words, in this embodiment, the assets presented to the end user may be stored separately from the client 1322. In one embodiment, the client 1322 requests the assets appropriate for the game played by the user; in other embodiments, especially those using thin clients, just those assets that are needed for a particular display event will be sent by game server 1306 when the game server 1306 determines they are needed, including as few as one asset. In one example, the client 1322 may call a function defined at the user interaction server 1302 or asset server 1304, which may determine which assets are to be delivered to the client 1322 as well as how the assets are to be presented by the client 1322 to the end user. Different assets may correspond to the various clients that may have access to the game server 1306 or to different games to be played.

The game server 1306 is configured to perform game play methods and determine game play outcomes that are provided to the user interaction server 1302 to be transmitted to the user device 1320 for display on the end user's computer. For example, the game server 1306 may include game rules for one or more wagering games, such that the game server 1306 controls some or all of the game flow for a selected wagering game as well as the determined game outcomes. The game server 1306 may include pay tables and other game logic. The game server 1306 also performs random number generation for determining random game elements of the wagering game. In one embodiment, the game server 1306 is separated from the user interaction server 1302 by a firewall or other method of preventing unauthorized access to the game server 1306 from the general members of the network 1330.

The user device 1320 may present a gaming interface to the player and communicate the user interaction to the gaming system 1300. The user device 1320 may be any electronic system capable of displaying gaming information, receiving user input, and communicating the user input to the gaming system 1300. As such, the user device 1320 can be a desktop computer, a laptop, a tablet computer, a set-top box, a mobile device (including, but not limited to, a smartphone), a kiosk, a terminal, or another computing device. The user device 1320 operating the client 1322 may comprise an interactive electronic gaming system, such as the gaming system 100 (see FIG. 1). The client 1322 may be a specialized application or may be executed within a generalized application capable of interpreting instructions from an interactive gaming system, such as a web browser.

The client 1322 may interface with an end user through a web page or an application that runs on a device including, but not limited to, a smartphone, a tablet, or a general computer, or the client 1322 may be any other computer program configurable to access the gaming system 1300. The client 1322 may be illustrated within a casino webpage (or another interface) indicating that the client 1322 is embedded into a webpage, which is supported by a web browser executing on the user device 1320.

In one embodiment, the gaming system 1300 may be operated by a different entity than the operator of the client 1322. The hardware of gaming system 1300 may be located remotely from the client 1322. The user device 1320 may be operated by a third party, such as a casino or an individual, that links to the gaming system 1300, which may be operated, for example, by a wagering game service provider. Therefore, in some embodiments, the user device 1320 and the client 1322 may be operated by a different administrator than the operator of the game server 1306, and the user device 1320 and the client 1322 may also be operated by separate administrators. In other words, the user device 1320 may be part of a third-party system that does not administer or otherwise control the gaming system 1300 or game server 1306.

In another embodiment, the user interaction server 1302 and asset server 1304 are provided by a third-party system. For example, a gaming entity (e.g., a casino) may operate the user interaction server 1302 or user device 1320 to provide its customers access to game content managed by a different entity that may control game server 1306, amongst other functionalities. In some embodiments, these functions are operated by the same administrator. For example, a gaming entity (e.g., a casino) may elect to perform each of these functions in-house, such as providing both the access to the user device 1320 and the actual game content and providing administration of the gaming system 1300.

The gaming system 1300 may communicate with one or more external account servers 1310, optionally through another firewall. For example, the gaming system 1300 itself may not directly accept wagers or issue payouts. That is, the gaming system 1300 may facilitate online casino gaming but may not be part of a self-contained online casino itself. Instead, the gaming system 1300 may facilitate the play of wagering games owned and controlled by a company offering games and gaming products and services, such as SHFL entertainment, Inc. Another entity (e.g., a casino or any account holder or financial system of record) may operate and maintain its external account servers 1310 to accept bets and make payout distributions. The gaming system 1300 may communicate with the account servers 1310 to verify the existence of funds for wagering and to instruct the account server 1310 to execute debits and credits.

In some embodiments, the gaming system 1300 may directly accept bets and make payout distributions, such as in the case where an administrator of the gaming system 1300 operates as the client 1322. As discussed above, the gaming system 1300 may be integrated within the operations of a casino rather than separating out functionality (e.g., game content, game play, credits, debits, etc.) among different entities. In addition, for play-for-fun wagering games, the gaming system 1300 may issue credits, take bets, and manage the balance of the credits according to the game outcomes, but the gaming system 1300 may not permit payout distributions or be linked to an account server 1310 that permits payout distributions. Such credits may be issued for free, through purchase, or for other reasons, without the ability for the player to cash out. Such play-for-fun wagering games may be administered on platforms that do not permit traditional gambling, such as to comply with jurisdictions that do not permit online gambling. In embodiments where a user device 1320 accesses games administered by gaming system 1300 through the client 1322, the account server 1310 contains “mirror accounts” that track account balances to confirm wagers have been made and there are funds to support the wagers before delivering game results. In this embodiment, no actual player funds are handled by the account server 1310.

The gaming system 1300 may be configured in many ways, from a fully integrated single system to a distributed server architecture. The asset server 1304, the user interaction server 1302, the game server 1306, and the account server 1310 may be configured as a single, integrated system of code modules running on a single server or machine, where each of the servers is functionally implemented on a single machine. In such a case, the functionality described herein may not be implemented as separate code modules. The asset server 1304, the user interaction server 1302, the game server 1306, and the account server 1310 may also be implemented as a plurality of independent servers, each using its own code modules running on a separate physical machine, and may further include one or more firewalls between selected servers (depending on security needs). Each server could communicate over some kind of networked connection, potentially as varied as that described for network 1330. Further, each single server shown in FIG. 6 may be implemented as a plurality of servers with load balancing and scalability factors built into the embodiment. All such embodiments and variations are fully contemplated.

Additional features may be supported by the game server 1306, such as hacking and cheating detection, data storage and archival, metrics generation, messages generation, output formatting for different end user devices, as well as other features and operations. For example, the gaming system 1300 may include additional features and configurations as described in U.S. patent application Ser. No. 13/353,194, filed Jan. 18, 2012, and U.S. patent application Ser. No. 13/609,031, filed Sep. 10, 2012, both titled “NETWORK GAMING ARCHITECTURE, GAMING SYSTEMS, AND RELATED METHODS,” the disclosures of which are incorporated herein in their entirety by this reference.

The network 1330 may enable communications between the user device 1320 and the gaming system 1300, and the user device 1320 and the online casino client 1322. A network may also connect the gaming system 1300 and account server 1310, and, further, one or more networks may interconnect one or more of the other servers shown collectively as the game system 1300. In one embodiment, the network 1330 uses standard communications technologies and/or protocols. Thus, the network 1330 can include links using technologies such as Ethernet, 802.11, worldwide interoperability for microwave access (WIMAX®, 3G, digital subscriber line (DSL), asynchronous transfer mode (ATM), INFINIBAND®, PCI Express Advanced Switching, etc. Similarly, the networking protocols used on the network 1330 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1330 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 1330 can include links comprising one or more networks such as the Internet.

FIG. 8 is a block diagram of a computer system 1400 according to one or more embodiments. In one embodiment, the computer system 1400 can be used for acting as at least some portion of the gaming system 100 (see FIG. 1) or the gaming system 1300 (see FIG. 7). The computer system 1400 includes at least one processor 1442 coupled to a chipset 1444, as indicated in dashed lines. Also coupled to the chipset 1444 are memory 1446, a storage device 1448, a keyboard 1450, a graphics adapter 1452, a pointing device 1454, and a network adapter 1456. A display 1458 is coupled to the graphics adapter 1452. In one embodiment, the functionality of the chipset 1444 is provided by a memory controller hub 1460 and an I/O controller hub 1462. In another embodiment, the memory 1446 is coupled directly to the processor 1442 instead of to the chipset 1444.

The storage device 1448 is any non-transitory computer-readable storage medium, such as a hard drive, a compact disc read-only memory (CD-ROM), a DVD, or a solid-state memory device (e.g., a flash drive). The memory 1446 holds instructions and data used by the processor 1442. The pointing device 1454 may be a mouse, a track pad, a track ball, or another type of pointing device, and it is used in combination with the keyboard 1450 to input data into the computer system 1400. The graphics adapter 1452 displays images and other information on the display 1458. The network adapter 1456 couples the computer system 1400 to a local or wide area network.

As is known in the art, the computer system 1400 can have different and/or other components than those shown in FIG. 8. In addition, the computer system 1400 can lack certain illustrated components. In one embodiment, the computer system 1400 acting as the gaming system 100 (FIG. 1) lacks the keyboard 1450, pointing device 1454, graphics adapter 1452, and/or display 1458. Moreover, the storage device 1448 can be local and/or remote from the computer system 1400 (such as embodied within a storage area network (SAN)). Moreover, other input devices, such as, for example, touch screens may be included.

The network adapter 1456 (may also be referred to herein as a communication device) may include one or more devices for communicating using one or more of the communication media and protocols discussed above with respect to FIG. 1.

In addition, some or all of the components of this general computer system 1400 of FIG. 8 may be used as part of the processor and memory discussed above with respect to the systems or devices described for FIG. 1, FIG. 2, FIG. 3, FIG. 4, FIG. 5A, FIG. 5B, FIG. 5C, or FIG. 6.

The gaming system 100 (FIG. 1) and/or the gaming system 1300 (FIG. 7) may comprise several such computer systems 1400. The gaming system 100 may include load balancers, firewalls, and various other components for assisting the gaming system 100 to provide services to a variety of user devices.

The computer system 1400 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 1448, loaded into the memory 1446, and executed by the processor 1442.

FIG. 3, described by way of examples above, represents at least one algorithm that correspond to at least some instructions stored and executed by the game-logic circuitry associated with any of the systems or devices described for FIG. 1, FIG. 2, FIG. 4, FIG. 5A, FIG. 5B, FIG. 5C, FIG. 6, FIG. 7, or FIG. 8 to perform the above described functions associated with the disclosed concepts.

Any component of any embodiment described herein may include hardware, software, or any combination thereof.

Further, the operations described herein can be performed in any sensible order. Any operations not required for proper operation can be optional. Further, all methods described herein can also be stored as instructions on a computer readable storage medium, which instructions are operable by a computer processor. All variations and features described herein can be combined with any other features described herein without limitation. All features in all documents incorporated by reference herein can be combined with any feature(s) described herein, and also with all other features in all other documents incorporated by reference, without limitation. Features of various embodiments of the inventive subject matter described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments which are defined only by the appended claims. Further, since numerous modifications and changes may readily occur to those skilled in the art, it is not desired to limit the inventive subject matter to the exact construction and operation illustrated and described, and accordingly all suitable modifications and equivalents may be resorted to, falling within the scope of the inventive subject matter.

1. A method comprising:
tracking, by a processor, outcome results data for a range of roulette games performed by a roulette gaming system;
determining, by the processor based on analysis of the outcome results data, a zone on a roulette wheel that contains a subset of wheel number values associated with the outcome results data, wherein the subset of wheel number values are associated with contiguous numbered segments of the roulette wheel;
animating, by the processor, a highlight effect overlaid onto a portion of the roulette wheel associated with the zone;
animating, by the processor, a section on a betting layout corresponding to the zone;
detecting, by the processor in response to user input for a given roulette game, placement of one or more tokens via the section, wherein the placement of the one or more tokens correspond to a user selection of the subset of wheel number values in the zone for the given roulette game;
presenting, by the processor via the roulette wheel, a random outcome for the given roulette game; and
automatically updating, by the processor, the outcome results data based on the outcome of the given roulette game, wherein the automatically updating the outcome results data automatically updates the zone.

2. The method of claim 1 further comprising automatically verifying, by the processor, that the amount of the one or more tokens is sufficient to cover the placement depending on a type of bet associated with the zone, and wherein presenting the random outcome is in response to the automatically verifying.

3. The method of claim 2, wherein the type of bet is one of either a single-value bet on each of the subset of wheel number values in the zone or a multi-value bet on any of the subset of wheel number values.

4. The method of claim 3, wherein the placement of the single-value bet is a different minimum bet amount than the multi-value bet.

5. The method of claim 2, wherein the one or more tokens are one or more virtual tokens, and wherein the verifying that the amount of the one or more virtual tokens is sufficient to cover the placement comprises:
determining that, based on the type of bet selected for the zone, that the amount of the one or more virtual tokens is insufficient to cover a minimum bet amount for the zone; and
automatically performing, by the processor, at least one of placing additional virtual tokens on additional sections of the betting layout that correspond to each layout number value associated with each of the subset of wheel number values, distributing a value of the one or more virtual tokens across the subset of wheel number values, or presenting, via a participant terminal, a message indicating an additional amount of virtual tokens that are required to meet the minimum bet amount.

6. The method of claim 1, wherein the roulette gaming system is an electronic roulette system, wherein the roulette wheel is a virtual roulette wheel, wherein the animating the highlight effect comprises animating the highlight effect overlaid onto the portion of the virtual roulette wheel, wherein the animating the section on the betting layout comprises animating the section on a virtual betting layout presented via a graphical user interface (GUI) of a player terminal of the electronic roulette system, wherein the detecting the placement of the one or more tokens comprises detecting, by the processor in response to user input received via the GUI, placement of one or more virtual tokens via the section, wherein presenting the random outcome comprises animating, by the processor based on a random number generator (RNG), the random outcome via the virtual roulette wheel, and wherein the automatically updating the outcome results data based on the outcome of the given roulette game comprises automatically updating a location of the zone and automatically updating the outcome results data within the updated location of the zone.

7. The method of claim 1 further comprising animating, by the processor, additional highlight effects associated with the zone, wherein the additional highlight effects specify statistics of occurrence of each wheel number value of the roulette wheel for the range of roulette games.

8. The method of claim 1, wherein the determining the zone is further based on one or more settings which comprises at least one of a setting that specifies the range of roulette games of over a last given number of roulette games, a setting that specifies a visual property of the zone, a setting that specifies a size of the subset of wheel number values associated with the zone, a setting that specifies a range of possible sizes for the subset of wheel number values within the zone, or a setting that specifies a range of different sizes of subsets of wheel number values associated with a plurality of zones.

9. The method of claim 1, wherein the determining the zone is further based on a hierarchy of a statistical levels associated with a combined statistical condition for the subset of wheel number values, and wherein animating the highlight effect comprises modifying a property of the highlight effect to a degree based on a statistical level assigned to the zone from the hierarchy.

10. The method of claim 1, wherein animating the section comprises at least one of animating a label that identifies the zone, animating a listing of members of the subset of wheel number values associated with the zone, or animating a betting spot for placement of the one or more tokens as a bet on the zone.

11. The method of claim 1 further comprising:
detecting, by the processor in response to the placement of the one or more tokens, one of a plurality of bet types that is associated with the zone for the given roulette game, wherein the plurality of bet types comprises at least one of a multi-value bet type and a single-value bet type; and
placing, by the processor, one or more bets for the members of the subset of wheel number values based on the detected one of the plurality of bet types.

12. The method of claim 1, wherein the subset of wheel number values comprises members whose combined average statistical outcome occurrence is higher than that of any other subset of wheel number values on any other contiguous numbered segments on the roulette wheel.

13. The method of claim 1, wherein the zone is one of a plurality of zones on the roulette wheel, wherein animating the highlight effect comprises animating the highlight effect onto a plurality of portions of the roulette wheel having different subsets of wheel number values associated respectively with each of the plurality of zones, and wherein each of the plurality of zones are associated with a different one of a hierarchy of levels.

14. A system comprising:
an image sensor;
a digital display; and
a processor, wherein the processor is configured to execute instructions, which when executed, cause the system to perform operations to:
track, via the image sensor, outcome data of a physical roulette wheel for each wheel number value at a physical gaming table over a given range of roulette games;
store the outcome data in a computer memory;
present, via the digital display, a virtual representation of the physical roulette wheel;
animate, via the digital display in response to automated analysis of the outcome data, a highlight effect over a zone of the virtual representation, wherein the zone corresponds to a combined statistic associated with a subset of roulette wheel values over the given range of roulette games; and
automatically highlight, during a roulette game, a set of one or more bet spots on a betting layout, wherein the set of one or more bet spots are for placement of one or more betting tokens associated with the subset of roulette wheel values in the zone.

15. The system of claim 14, wherein the processor is configured to automatically highlight the set of one or more bet spots via a virtual betting layout on a dealer terminal.

16. The system of claim 15, wherein the processor is configured to automatically highlight the set of one or more bet spots via presentation of indicators on a physical betting layout on a surface of the physical gaming table.

17. The system of claim 16, wherein the presentation of indicators comprises one or more of projection, via a projector associated with the physical gaming table, of the indicators onto the set of one or more bet spots on the physical betting layout or back lighting the set of one or more bet spots from underneath a table felt associated with the physical betting layout.

18. The system of claim 14, wherein the processor is further configured to execute one or more instructions that cause the system to perform operations to automatically highlight the set of one or more bet spots on the betting layout in response to at least one of a croupier input at a dealer station regarding a called player bet for the zone or machine learning model image analysis of player activity that indicates a player bet for the zone.

19. The system of claim 14, wherein the processor is configured to execute instructions which, when executed, cause the system to perform further operations to:
capture, by the image sensor, an image of the set of one or more bet spots during a betting stage of the roulette game;
detect, via analysis of the image by a machine learning model trained to identify betting token values, placement of the one or more betting tokens on the set of one or more bet spots;
detect, via analysis of the image by the machine learning model, a value of the one or more betting tokens;
automatically determine, in response to detection of the value, whether the value covers a minimum bet amount required for the subset of roulette wheel values in the zone; and
provide, via a dealer terminal, an indication as to whether the minimum bet amount is covered.

20. The system of claim 14, wherein the processor is further configured to execute one or more instructions that cause the system to perform operations to automatically highlight the set of one or more bet spots for distribution of the one or more betting tokens to individual layout number values corresponding to the subset of roulette wheel values.
